(19) United States
(12) Patent Application Publication
(10) Pub. No.: US 2019/0274275 A1
(43) Pub. Date: Sep. 12, 2019

(54) REPTILE CAGE LINER

(71) Applicant: Daniel David Sutherland, Mapleton, UT (US)

(72) Inventor: Daniel David Sutherland, Mapleton, UT (US)

(21) Appl. No.: 16/288,661

(22) Filed: Feb. 28, 2019

Related U.S. Application Data
(60) Provisional application No. 62/639,111, filed on Mar. 6, 2018.

(51) Int. Cl. A01K 1/015; B31D 5/00; B31D 5/04

(52) U.S. Cl. CPC A01K 1/0157; B31D 2205/00; B31D 5/04; B31D 5/0021

(57) ABSTRACT

A reptile cage liner is formed as a blank having selective cuts and creases to reduce section modulus to provide a stiff but foldable wall (flap) on each side of a rectangular floor. Flaps fold or bend preferentially along creases to form the liner. Residual stiffness of creases urges edges of the flaps to seal by contacting walls of a cage tray. Corner, funnel tabs tilt downward and extend laterally from each side flap across a corner gap to prevent escape of bedding, food, or other debris into corners or behind the liner. Liners may be easily replaceable and disposable.

### BACKGROUND

### 1. Related Applications

This application claims the benefit of U.S. Provisional Patent Application Ser. No. 62/639,111, filed Mar. 6, 2018, which is hereby incorporated by reference in its entirety.

### 2. The Field of the Invention

This invention relates to shelters and housing for pets and other animals and, more particularly, to novel systems and methods for cage liners.

### 3. The Background Art

Animals are often kept as pets, the most common being dogs and cats. Some pets are considered outdoor pets and others are indoor pets. Nevertheless, even outdoor animals including ferrets, hedgehogs, potbelly pigs, rabbits, and the like may also be maintained as indoor pets.

Meanwhile, other pets are often kept in a terrarium or aquarium. For example, reptiles, amphibians like turtles and salamanders, and fish may be kept in a terrarium or aquarium, respectively. Reptiles may include cayman, alligators, crocodiles, snakes, and so forth.

A significant portion of care for pets is housing. Likewise, hygiene and clean-up after pets are of perennial concern. Typically, loose bedding may be provided for ground animals, including many mammals, like guinea pigs, hamsters, and rabbits, or even reptiles, and the like. Meanwhile, birds may typically be provided with roosts, possibly a shelter, and the proverbial bottom of the bird cage with a liner, such as newspaper.

Typically, snakes and other “creeping” reptiles are maintained by an owner in a shelter, such as a terrarium. On the other hand, purveyors of pets (pet shops) typically stock higher volumes of pets and have less commodious dwelling spaces, often stockpiling cages and racks. Necessarily, cages require maintenance.

Typically, loose bedding such as aspen chips, other wood products, and the like may form a bedding material or layer of absorbent material that will periodically be changed in a cage system. Necessarily, periodically, the trays, crates or boxes in which animals are kept will also need to be cleaned, since they are soiled also, to some extent. Bedding changes are necessarily somewhat time consuming, as is clean up of cages or boxes. In the case of reptiles, and specifically snakes, the clean-up is inconvenient, time consuming, and perhaps somewhat inconsistent with the living habits of the cage reptiles.

For example, reptiles are typically kept in boxes or trays that do not have any “large” openings that would pass a small (infant) snake, or a fang. In fact, breathing air is often provided through small (less than ¼ inch, or ½ centimeter) effective diameter on openings. Typically, a tray includes solid walls with no perforations and a solid bottom. The tray slides into a rack, like a box covered on its top surface by a perforated plate of the rack. Clearances are comparatively close in order to provide both security against escape and protection against any material, including bedding, feces, or other products being discharged by pushing or flipping out through openings. Thus, a close clearance is considered to be less than about ¼ inch (half a centimeter) and usually half that.

What is needed is a convenient, quick, comparatively secure and complete containment for waste products that may accumulate in a cage for animals, particularly reptiles, and more particularly for snakes. It would be an advance in the art to provide a system that would be easily prepared, easily inserted into a cage, and easily changed when appropriate.

### SUMMARY OF THE INVENTION

In view of the foregoing, in accordance with the invention as embodied and broadly described herein, a method and apparatus are disclosed in one embodiment of the present invention as including a habitat or system that may include a rack having vertical legs with horizontal braces front to back and lateral beams running left to right between the legs, and a system of trays that fit into the rack between the beams. Typically, a ceiling may fit against the top opening of a tray in order to contain the animal therein. In certain embodiments, a trough or reservoir may provide a water supply for the animal contained therein.

A liner for the trays is provided with a material such as corrugated cardboard or pasteboard precut, including optional die cutting of removable portions, and creases or other lines providing reduced section modulus (a term of art well understood in the mechanical arts, and used here in its ordinary meaning, as a property that effects the strength or stiffness of any material in bending). The section modulus may be decreased by a score line, a crease, or the like to decrease the effective thickness between two sides or two opposing panels of a corrugated material.

Although corrugated plastic is one option, a disposable, corrugated, cardboard liner may be preferable. Creases may provide for a decreased section modulus and therefore a preferential location for bending. Thus, the floor of a liner may be surrounded by walls as flaps, each of which bends readily and preferentially at a crease in order to assure an even sizing of the floor and of each of the walls.

Typically, near corners of a cage tray, a funnel tab may extend from a side flap to protect against escape by any materials, whether bedding, waste, food, or the like between adjacent walls (flaps), such as end walls and side walls (flaps). These tabs may fit inside the liner between a side wall and an end wall in order to permit each of the walls to fit snuggly and seal effectively against the corresponding walls of the cage tray.

In certain embodiments, cages may include a reservoir or trough molded with the tray itself. In such a situation, the liner may include a die cut knock-out or cover that effectively continues the floor, but may be selectively removed in order to fit around a trough built into the tray of a cage.

In methods in accordance with the invention, one may determine a size range or variety of sizes that are desired to be fit by a particular liner. Then, a blank may be provided by cutting from stock a supply of blanks or standard rectangles that will eventually become liners. Relief cuts may be provided in order to make room for the tabs to be folded, and for the walls to be folded up toward one another above the floor.

Likewise, creases may be provided or other mechanisms may be used to provide reduced section modulus in the liner material at the boundaries between the floor and each wall. Accordingly, the material of the liner may be scored, cut at one of the outer surfaces, stamped to crease it and crush the corrugated material between the two outer layers, and so forth.

In use, one may select a size of a blank in accordance with the size of a cage, comparing the floor of each. One may then bend the blank on the fold lines or creases in order to move the walls (end and side walls) upward at approximately right angles with respect to the floor. In reality, the side walls should not be at right angles. The objective is not to form a box, but to form a liner. Thus, the walls are bent upward, and the tabs near the corners are folded into being included within the walls of the liner. Thus, the tabs, typically extend from the ends of the side walls, and tuck inside the end walls of the liner.

If a trough is provided in the cage, then one may remove a knock-out or a die-cut area of the floor fitted to snugly surround the trough, and permit the floor to drop down to the floor of the cage tray even in the presence of the trough.

The user will typically hold two opposite corners of the liner together with the end wall and side wall held together. Thus, a user may now insert the liner into the cage tray and release the walls. At this point, the walls (flaps) maintaining residual stiffness, will automatically bend outward to the extent possible against the cage walls, thus forming a seal against the (typically plastic) solid wall of the cage tray. At this point, a user may add bedding to the liner if desired.

In certain embodiments, one may remove or replace the liner when a new animal is placed in a cage. Alternatively, one may monitor the cages periodically, optionally change bedding if other bedding besides the liner is used, and ultimately remove the liner when appropriate, due to dampening, soiling, or other condition that makes replacement appropriate. At that point, the liner can be removed, replaced, and the animal can be placed back in the cage, or a new animal may be placed in the cage.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of one embodiment of a system including a rack and cage trays suitable for animals such as reptiles, and particularly snakes;

FIG. 2 is a perspective view of such a tray provided with a liner in accordance with the invention;

FIG. 3 is an exploded perspective view of the tray of FIG. 2 with the liner ready for insertion;

FIG. 4 is a perspective view of one embodiment of a liner assembled for installation in accordance with the invention;

FIG. 5 is a top plan view thereof;

FIG. 6 is a bottom plan view thereof;

FIG. 7 is a side elevation view thereof, both the left and right sides being effectively identical;

FIG. 8 is a front elevation view thereof, the rear elevation view being substantially identical thereto;

FIG. 9 is a cut out or cutaway perspective view of a portion of the floor of a liner in accordance with the invention, with the die-cut knock-out piece shown in exploded view removed from the floor;

FIG. 10 is a perspective view of one embodiment of a blank for forming a liner in accordance with the invention;

FIG. 11 is a top plan view thereof;

FIG. 12 is a bottom plan view thereof;

FIG. 13 is a left side elevation view of the blank of FIG. 10;

FIG. 14 is a right side elevation view thereof;

FIG. 15 is a front elevation view thereof;

FIG. 16 is a rear elevation view thereof; and

FIG. 17 is a process for making and using liners in a system in accordance with the invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

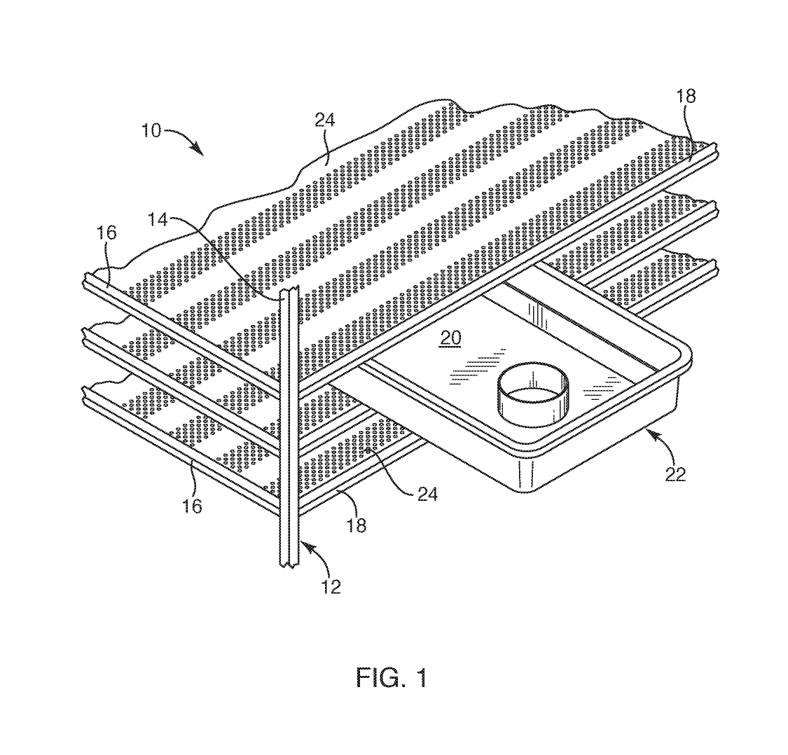

Referring to FIGS. 1 through 9, a system 10 or habitat 10 in accordance with the invention may begin with a rack 12. The rack 12 may typically be formed with vertical legs 14 secured in a front rear horizontal direction by braces 16. Meanwhile, longer beams 18 may extend left to right between the legs 14 in order to form a support for trays 22.

The trays 22 act as cages 22, and may be thought of as boxes 22 closed on five sides of six. The sixth or top side of the boxes 22 or trays 22 will be closed when they slide into the rack 12. Typically, the trays 22 slide across the beam 18, to fit against a ceiling 24. The ceiling 24 may appear like a bottom 24, or a shelf 24 extending completely between the braces 16, beams 18, as well as the legs 14. However, the ceiling 24 is typically secured by welding, riveting, or other fastening to fit against the bottom surfaces of the braces 16 and beams 18, in order to form a comparatively close (within about ¼ inch, or half a centimeter) of the top edge of each tray 22. This prevents escape of bedding, animals, or the like.

For example, snakes may be comparatively small. This may be due to the breed of the snake or the age of the snake. Thus, gaps are preferably less than about ¼ inch (½ centimeter) between the tray 22 and the ceiling 24. In fact, in most embodiments, only sufficient clearance to provide a tolerance for an easy fit is permitted. Thus, typically less than ⅛ inch (¼ centimeter) is provided as clearance between the top edge of the tray 22 and the ceiling 24 of the rack 12.

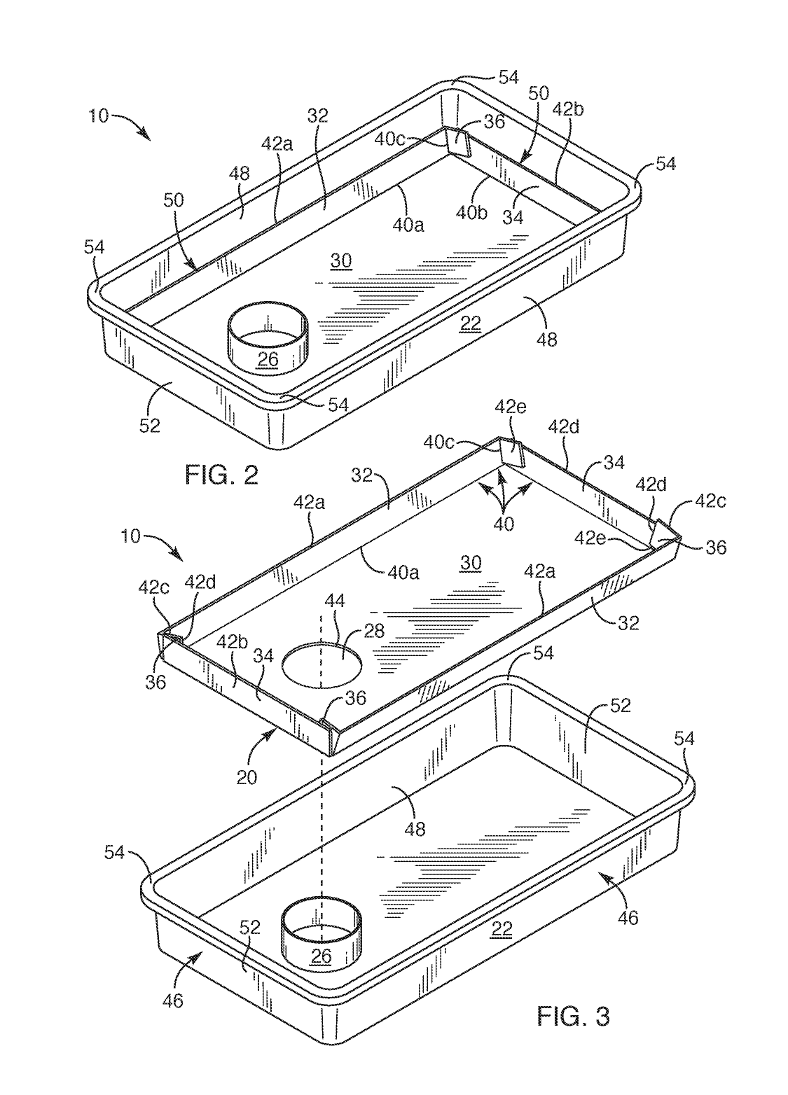

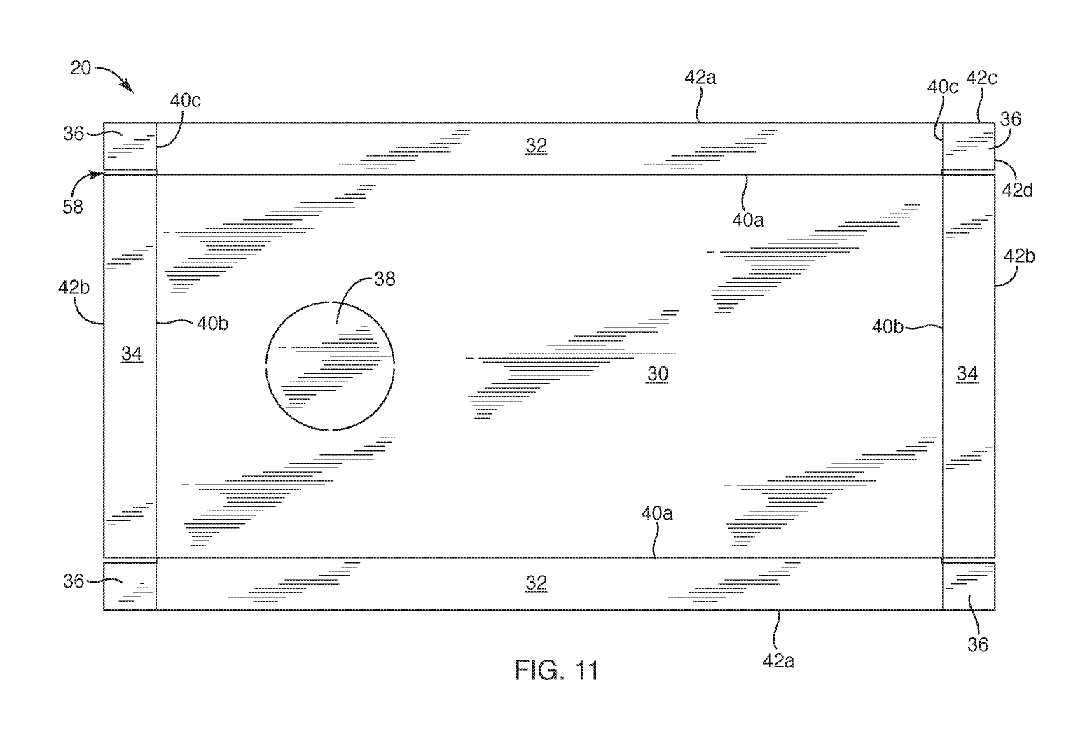

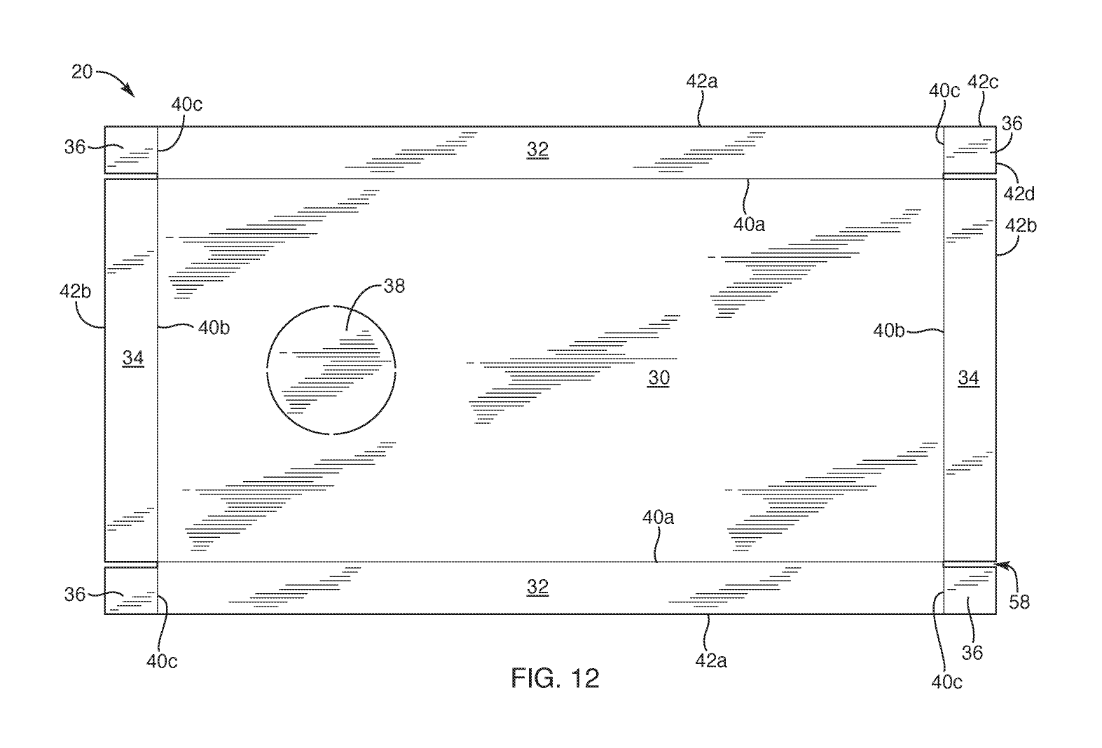

Referring to FIGS. 2 through 7, while continuing to refer generally to FIGS. 1 through 17, a liner 20 may fit within a tray 22 operating as a cage 22 for a reptile. The ceiling 24 or deck 24 operates to close the tray 22 from the top while the trough 26 provides a source of water for the occupant of the cage 22. Meanwhile, the floor 30 of the liner 20 effectively covers the bottom of the tray 22. The sides 32 extend upward from the floor 30 as flaps 32 to make contact with the walls 46, and particularly the side walls 48 of the tray 22. Similarly, the ends 34 or end flaps 34 of the liner 20 extend upward and outward from the floor 30 to contact the end walls 52 thereby forming a seal 50 or line of contact 50 between the liner 20 and the tray 22 on all sides.

Tabs 36 may extend from the sides 32 or the ends 34. In the illustrated embodiment, the tabs 36 extend from the sides 32, and bend to close the gap that would otherwise exist in the absence of an actual corner between each side 32 and its adjacent ends 34.

The tabs 36 may be trimmed to fit more perfectly, but the gap between the sides 32 and ends 34 is closed off by the tabs 36. Thus, the tabs 36 provide a funneling function in the absence of an actual right angled corner between each side 32 and its adjacent end 34.

Each bend in any material associated with the liner 20 or part of the liner 20 is made along a fold line 40 or crease 40. In certain embodiments, the creases 40 may be formed by a die crushing together a top surface and bottom surface of a corrugated material of which the liner 20 is constructed. Thus, any interior corrugation holding apart the outermost layers of the corrugated board will thereby be collapsed or reduced in height to lower their section modulus. Thus, any attempt to fold a side 32 or an end 34 between its outermost extremities will preferentially cause bending at a crease 40 along the fold line 40 precisely and reliably.

Opposite the creases 40a, 40b, 40c are corresponding edges 42a, 42b, 42c, 42d. Thus, each expanse 32, 34, whether a side 32 or end 34 is separated spatially from the floor 30 by a fold line 40, embodied as a crease 40a, 40b, 40c preferentially folding. Each terminates at a corresponding edge 42a, 42b, 42c, 42d. The edges 42, and more particularly the edges 42a, 42b corresponding to the sides 32 and ends 34 are beneficially able to extend at an obtuse angle away from the floor 30. They also extend away from each other in order to make contact with their corresponding walls 46, 48, 52 of the tray 22 operating as a cage 22.

In the illustrated embodiment, the edges 42a, 42b rest against corresponding side walls 48, and end walls 52, respectively. Thus, bedding, animals, debris, food, or the like will not be trapped or pushed into any open space between the sides 32, 34 and the walls 48, 52 corresponding thereto.

The tabs 36 may be folded inside the ends 34, if the tabs 36 originate as extensions of the sides 32. By the same token, the tabs 36 may be secured as extensions of the ends 34 or end flaps 34, and thereby fold inside sides 32 of the liner 20 and inside the boundary established by all the side flaps 32 and end flaps 34. A seal 50 need not be absolute. Nevertheless, by not forming the liner 20 as a box, the tabs 36 become an important closure mechanisms 36 an inclined slide 36 to close the gap existing between each side 32 and its adjacent ends 34 or end flaps 34.

As a practical matter, the tabs 36 will fit outside the sides 32 and ends 34 and against the walls 46 of the tray 22 if desired. However, this leaves a gap between the sides 32 and ends 34 with respect to the walls 46 of the tray 22. Small animals may actually hide in that space and be considered lost accidentally, or may push bedding, food, or other debris into that gap, or the like. Any of these results defeats to a certain extent the benefits of the liner 20 in the tray 22.

Thus, a better closure has effective seals 50 between each of the sides 32, or ends 34 and the corresponding side walls 48 and the end walls 52 of the tray 22. These are best accommodated when the tabs 36 fit within or inside the “envelope” (defined volume) established by the flaps 32, 34 of the liner 20 once installed in the tray 22.

One will note that the actual angle made by each tab 36 with respect to its base 32, 34 (side 32, end 34, depending on which serves as the base from which the tab 36 extends), is partly controlled by the presence of any adjacent end 34 or side 32, respectively. This affects the angle the tab 36 makes with the particular flap 32, 34 from which it extends, and to which it extends to make contact.

Because each of the sides 32 and ends 34 is typically made to extend from the floor 30 at an angle greater than ninety degrees (obtuse interior angle with respect to the floor 30), the tabs 36 tend to rise away from their base 32, 34. This gives them an interior angle with respect to the side 32 and end 34 immediately adjacent thereto, as well another angle with respect to the floor 30 itself, all obtuse, greater than ninety degrees. This is what is meant by the funnel tab 36 expression.

A precise corner of the floor 30 at which a side flap 32 and immediately adjacent end flap 34 connect is a right angle in a blank, still in a single horizontal plane. However, none of the lines or connections extending away from the horizontal plane of the floor 30 after “assembly” is thereby vertical or at right angles to the horizontal plane of the floor 30.

In certain embodiments, the tray 22 may be provided with a trough 26 or reservoir 26 that is actually formed, often literally molded, therewith. Accordingly, a knockout 38 may be die cut into the floor 30 to define a circular shape. Only certain comparatively small portions of that circle are actually cut through. Accordingly, a moderate pressure may be applied to the knockout 38 by fingers of a user, breaking any remaining connections between the knockout 38 or cover 38 and the rest of the floor 30. This reveals the aperture 28 through which the reservoir 26 may pass to sit above the floor 30.

As a practical matter, each of the tabs 36 becomes part of a dihedral angle existing between its adjacent base 32, 34, the floor 30, and the adjacent other member 34, 32 (end flap 34, side flap 32). The dihedral angle tends to form a funnel in the corner 54 to urge any bedding, debris, food, waste, or the like back toward the floor 30 and away from the seals 50 formed between the side flaps 32 and the side walls 48 of the tray 22, and the seal 50 between the end flap 34 and the end wall 52 of the tray 22.

The aperture 28 may be formed comparatively snuggly by sizing the cut out 38 or knockout 38 to have an interference fit, that is to have the exact same outer diameter of the aperture 28 as the outer diameter of the reservoir 246. Thus, a slight amount of bending, or other accommodation by the material of the floor 30 makes a snug (contact) fit between the aperture 28 and the reservoir 26.

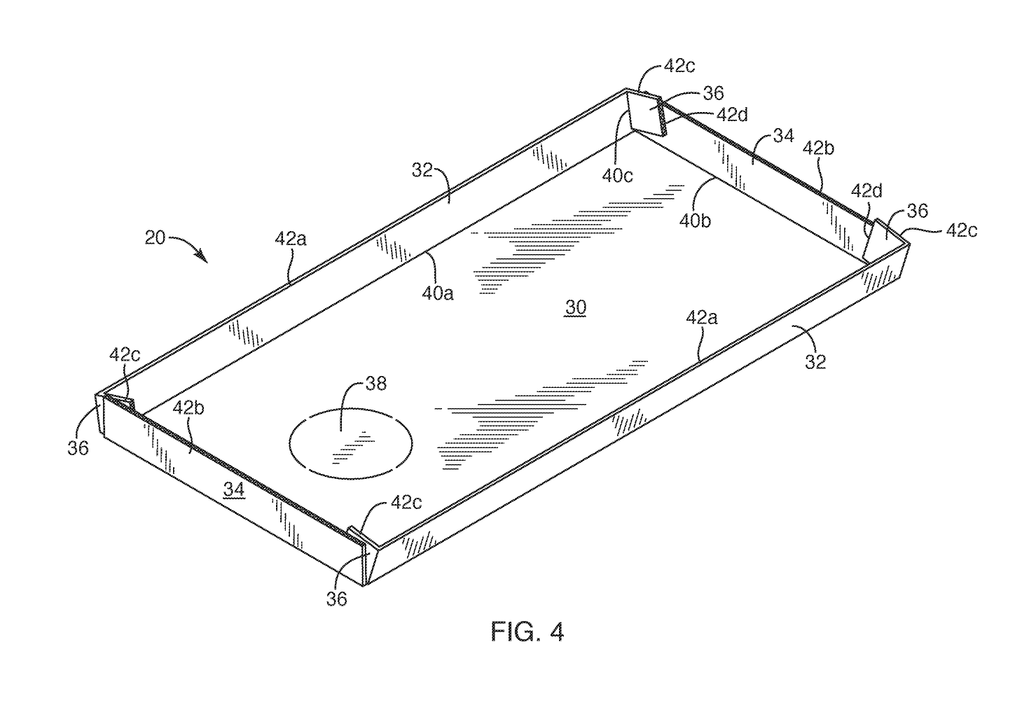

Referring to FIGS. 4 through 8, while continuing to refer generally to FIGS. 1 through 17, the perspective view of FIG. 4 shows the approximate position of the various members 32, 34, 36 with respect to the floor 30. Nevertheless, the exact angle made by each side flap 32 or end flap 34 depends on the specific size of the floor 30, and the tray 22. Typically, a liner 20 may be used with a range of sizes of trays 22. Thus, a comparatively smaller tray 22 may fit more closely the area of the floor 30 of the liner 20.

Meanwhile, engineering realities of manufacturing usually require a certain amount of draft angle (well understood in the plastics manufacturing art and used in that ordinary sense) in order to remove a newly manufactured tray 22 from the mold cavity in which it is formed. Accordingly, the walls 46 may extend typically away from the bottom of the tray 22 by an angle of from about ½ degree up to about five degrees greater than vertical. Meanwhile, the corners 54 of the tray 22 may actually be rounded. They will not require, nor fit a right angle at a corner of a box.

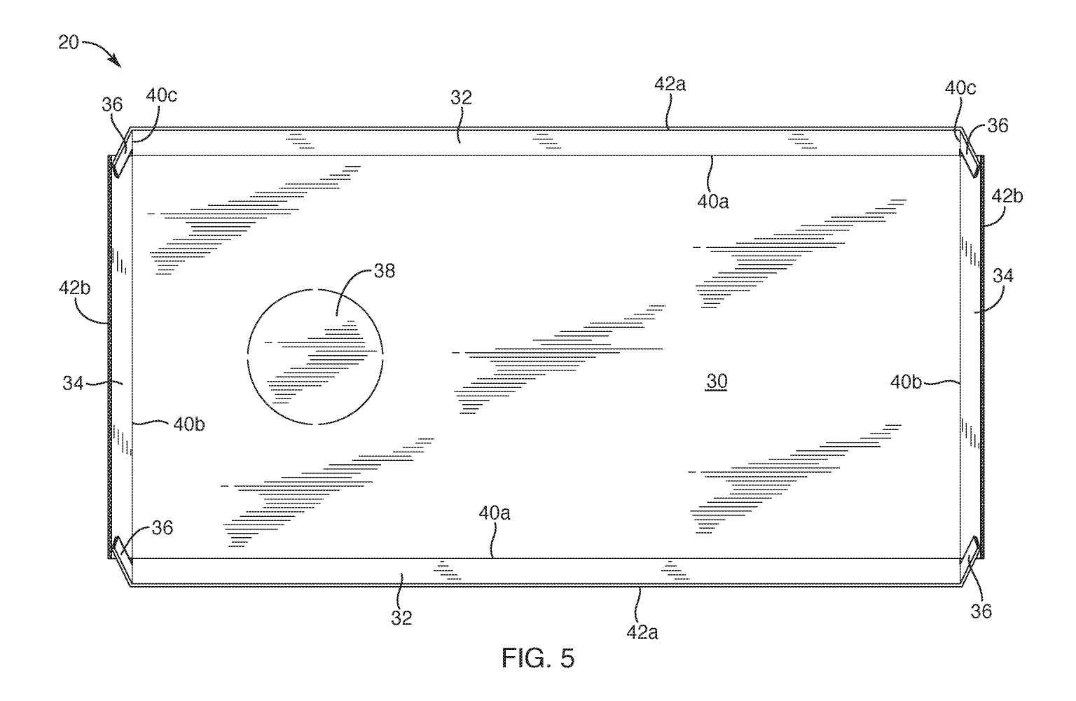

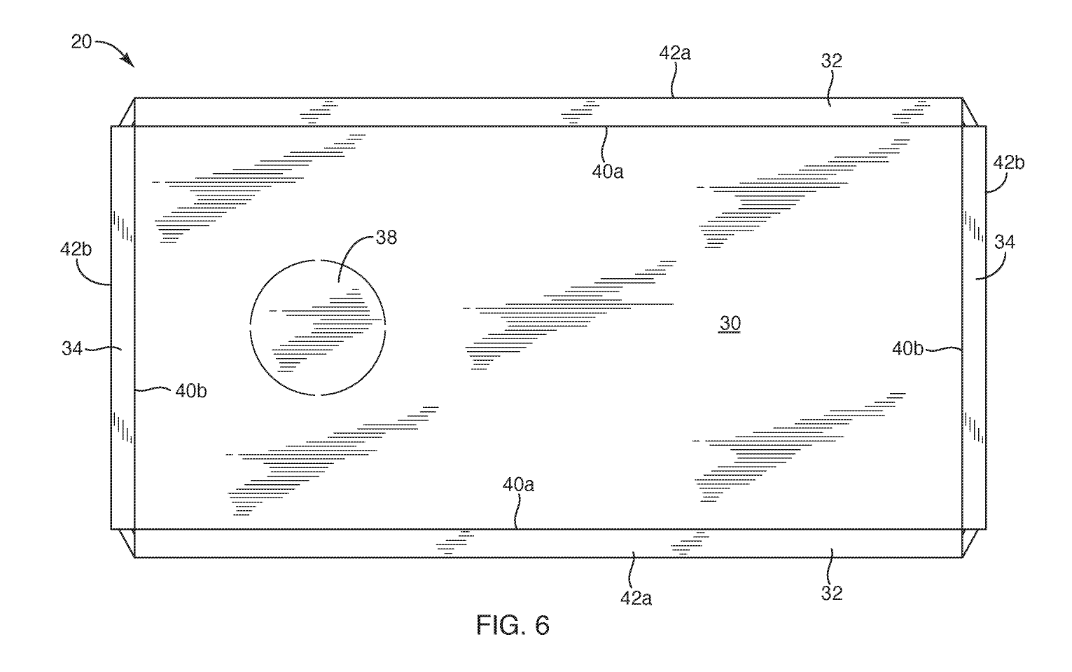

As seen in the top plan view of FIG. 5 and the bottom plan view of FIG. 6, residual stiffness exists in the material from which the liner 20 is formed. It will tend to push or cantilever the side flaps 32 and end flaps 34 away from the floor 30 at their respective edges 42a, 42b. A seal 50 forms along each side wall 48 and end wall 52 of the tray 22, while the tabs 36 or funnel tabs 36 effectively block any passage of materials from within the liner 20 to into the rounded corner 54 of the tray 22.

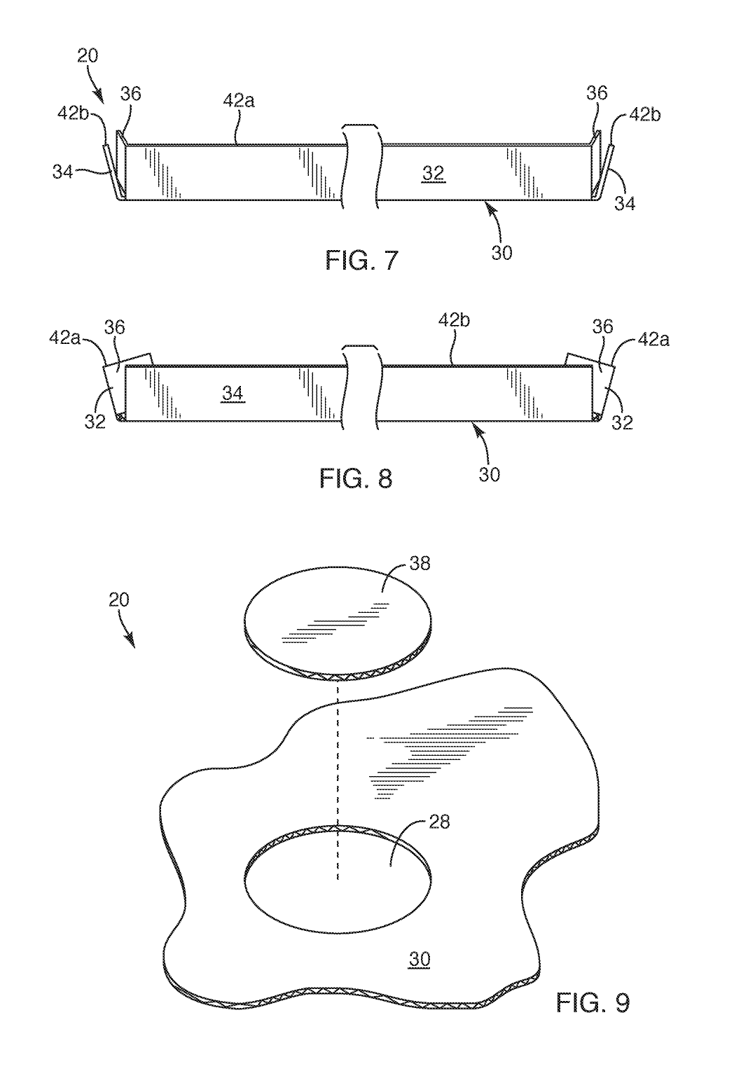

Referring to FIGS. 7 and 8, the relative angles in one configuration are illustrated for the liner 20. As set up, it is in a deployed configuration as if inside a tray 22. Meanwhile, the angles between the side flaps 32 and the floor 30 or between the end flaps 34 and the floor 30 may be greater or less in order to fit in contact with the respective side walls 48 and end walls 52 of the tray 22.

Referring to FIGS. 9 through 12, the aperture 28 and its knockout 38 will typically be arranged somewhere other than the center of the space within the liner 20. The reality is that an environ (inmate) of a tray 22 and liner 20 needs some space to move. Obstructing the living space within the area of the floor 30 by placing a reservoir 26 in the center thereof makes little sense. Thus, the reservoir 26 will typically be offset toward one end of the tray 22 and the liner 20.

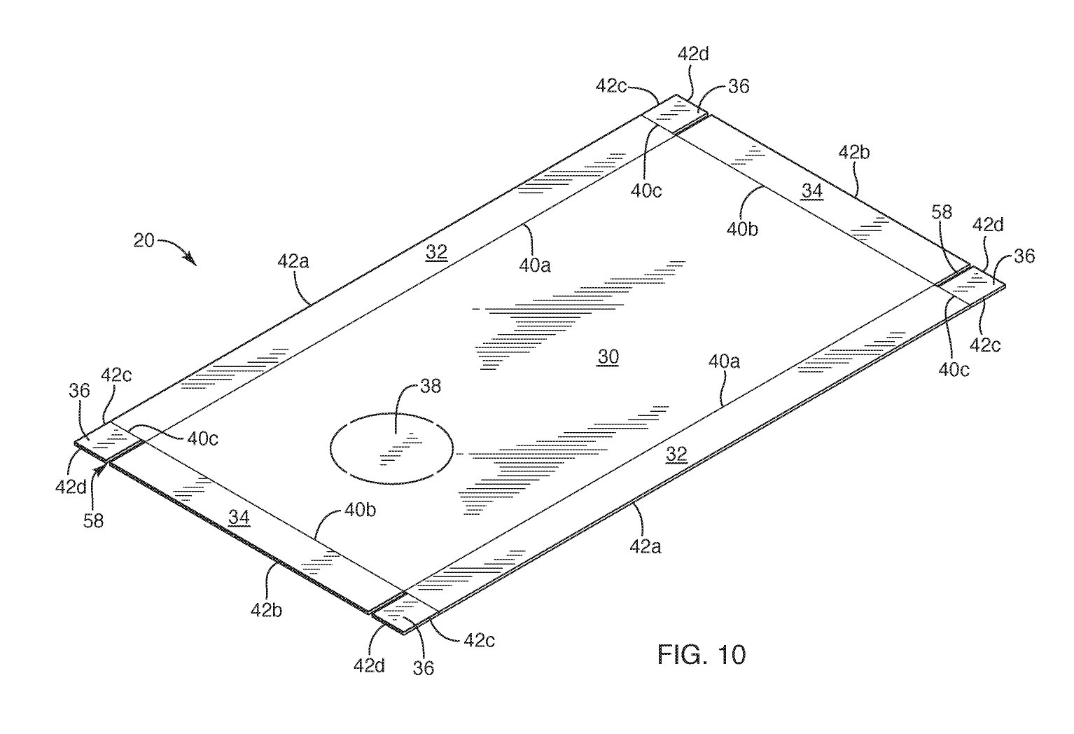

Referring to FIGS. 10 through 16, while continuing to refer generally to FIGS. 1 through 17, a blank of a liner 20 may be formed of a single flat sheet of cardstock, paper, cardboard, corrugated cardboard, or other material. Typically, a readily disposable liner 20 may be made from corrugated cardboard constituted by two flat, planar layers of Kraft paper bonded to an intermediate, corrugated spacer therebetween.

Putting the corrugated spacer between the outer layers of Kraft paper, increases the section modulus (defined as an integral relating base length along a neutral access to a depth or distance of an outermost fiber away from that neutral axis). Any book on the mechanics of materials or materials in general will include the equations. This property, section modulus affects strength and stiffness of a material. The value of corrugations in corrugated cardboard is that the strong and continuous outer layer of Kraft is at the outermost extremity (outermost fiber) of the material, greatly stiffening and strengthening the material in bending.

It has been found to work best if a relief cut 58 is made in either a side flap 32 or an end flap 34. For example, the tab 36 may operate as an extension of a side flap 32, as illustrated, but may also be constructed as an extension of an end flap 34. In the latter case, the relief cut 58 or slot 58 would be oriented at ninety degrees, thus separating the tab 36 from the side flap 32, and leaving the tab 36 joined to the end flap 34 by a fold line 40 or crease 40. Of course, as mentioned, a crease 40 is one mechanism, and a score line 40 is another. Often, a score line 40 may be cut into or partially through an outer surface of the material of the liner 20. In other embodiments, one layer of paper may be cut so that bending is more easily done along the opposite solid surface. However, it has been found suitable to use a crease line 40 in order to maintain the integrity of the outermost layers of the corrugated material, while still reducing a section modulus to provide preferential bending (folding) along the fold lines 40 or creases 40 as illustrated.

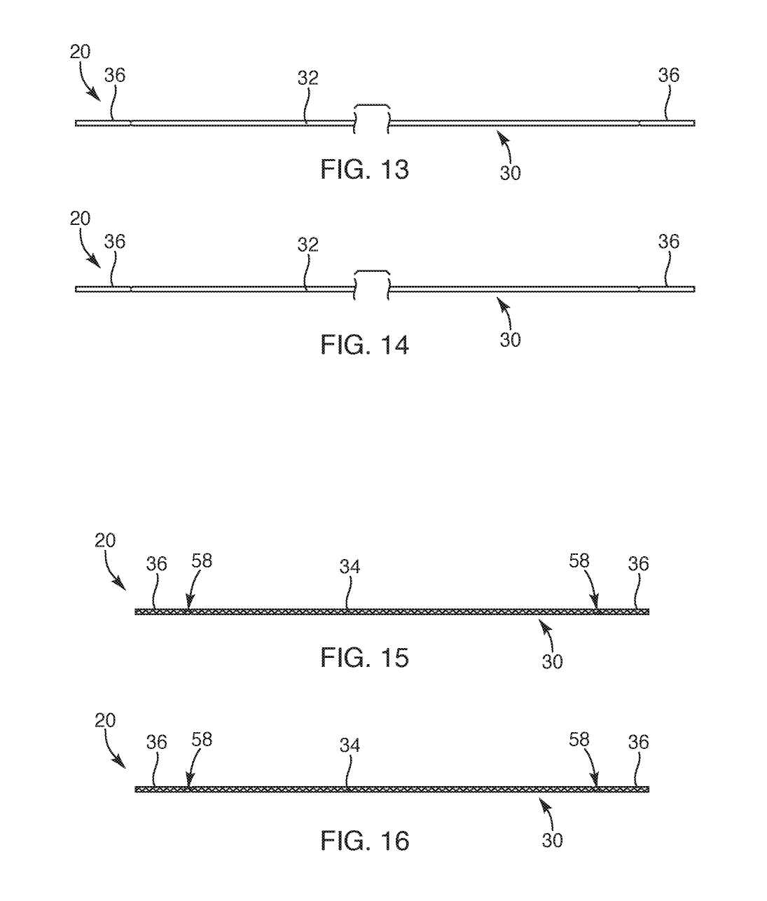

Referring to FIGS. 13 through 16, the edge views illustrated as side elevations and front and rear elevations are necessarily shortened by the cut lines as illustrated in order to not have the actual aspect ratio between thickness and length. Nevertheless, the cross sections of the edge views of the liners 20 in the unfolded or “blank” configuration illustrate the crease lines 40 or creases 40, again with the aspect ratio of thickness to length exaggerated by removing the section of material between the cut lines.

With the exception of the knockout 38 covering the aperture 28, the liners 20 may be comparatively symmetrical about an axial center line, as well as a lateral center line. That is, a center line may be run through the rectangle that forms the length of the flat liner 20 and each will represent substantially axial symmetry, with the exception of the existence of a knockout 38 to provide an aperture 28. In those embodiments in which such an aperture 28 is designed or desired. The floor 30 may be completely integral, with no die cut or knockout 38, in some embodiments.

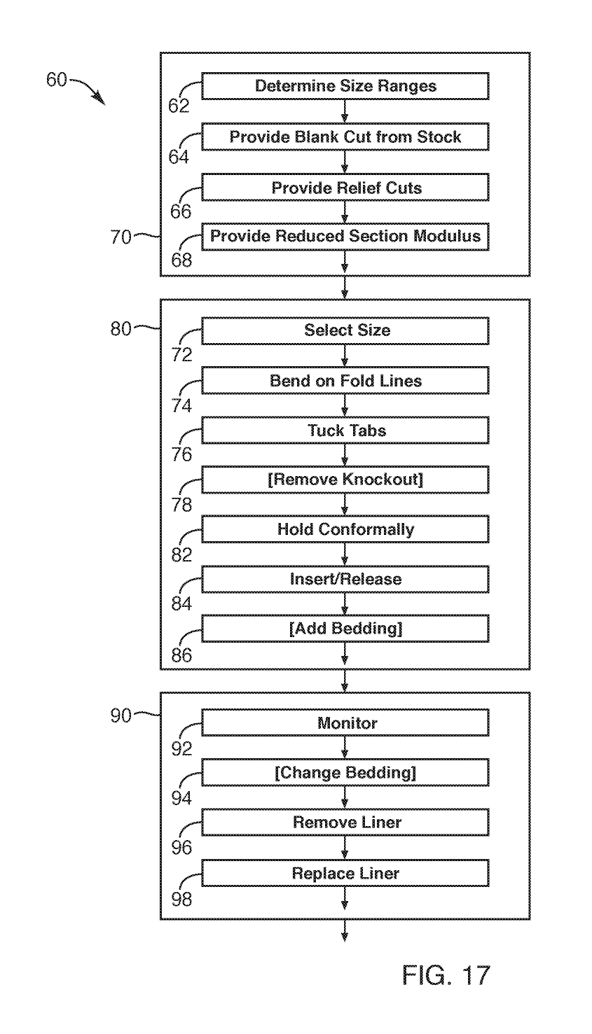

Referring to FIG. 17, in one embodiment of a method and apparatus creating and implementing a system 10, in accordance with the invention, and particularly liners 20, a process 60 may begin with determining 62 a size range that a liner 20 is expected to fit in a system 10 of trays 22. Thereafter, providing 64 a blank may include cutting from stock and providing fold lines 40 and relief cuts 58 as necessary. A single, flat layer results, which can be folded appropriately to provide a liner 20.

Providing 68 the relief cuts 58 may be done by the same die that basically provides 64 a blank. Similarly, if certain die cuts or die surfaces provide cuts, in a stamp-type process, then providing 68 the reduced section modulus may be done by bosses (raised areas) designed, sized, and engineered (effective) to crush interior corrugations. Such an operation decreases stiffness while not cutting through the outer layers of a corrugated material.

A manufacturing process 70 for making blanks may be done as a continuous process 70 by which a continuous sheet of material is cut to size. It may also be done in a batch process wherein an overall rectangular size is prepared, after which that material is run through die cuts and compressions to create fold lines 40.

A selection 72 of the size of a liner 20 to be used with a particular tray 22 size may be done once for all time. For example, if a pet shop has a set of racks 12 with standard trays 22, then those trays 22 will define what permissible size may be selected 72 for the liners 20. Accordingly, a user may then bend 74 the flaps 32, 34 and tabs 36 along their fold lines 40 or creases 40. The tabs 36 may be tucked 76 to lie inside the envelope of the liner 20 and the knockout 38 may be removed 78 at any appropriate time. In fact, the tabs 36 should typically be tucked 76 before the side flaps 32 and end flaps 34 are folded upward, in order that the tabs 36 not obstruct the positioning of the flaps 32, 34 against the walls 46.

Typically, in the process 80 of assembly 80, a user may hold 82 the side flaps 32 and end flaps 34 close to one another, even in a box-like shape before inserting 84 the liner 20 into the tray 22. Upon inserting 84 the liner 20 into the tray 22, the flaps 32, 34 may be released to extend outward. Their upper edges 42 will then rest against the respective side walls 48 and end walls 52 of the tray 22.

Typically, bedding may be added 86 as a matter of convention. Nevertheless, the label on this step 86 is in rectangular brackets, indicating that it is optional, just as the removal 78 of a knockout 38. Depending on the animal contained, bedding may be added 86, or the liner 20 may simply render bedding unnecessary with certain animals.

Maintenance 90 may involve monitoring 92 the liner 20 to determine whether it is still integral, whether it has become too soiled or damp for continued use, and whether it is otherwise completing its function. Optionally, changing 94 the bedding may or may not require changing out the liner 20. However, the life of the liner 20 may be extended if bedding is still used. One of the functions of the liner 20 is to limit the amount of ongoing cleaning required for the trays 22, which are typically durable plastic articles 22. Eventually, a liner 20 will be removed 96 for any number of reasons, the most common of which will be because it is soiled or incapable of continuing its function. At that point, the liner 20 may then be replaced 98 with a fresh liner 20 for ongoing use.

The present invention may be embodied in other specific forms without departing from its fundamental functions or essential characteristics. The described embodiments are to be considered in all respects only as illustrative, and not restrictive. All changes which come within the meaning and range of equivalency of the illustrative embodiments are to be embraced within their scope.

1. A method of bedding reptiles, comprising:
providing a plurality of containers configured as trays closed on five sides;
providing a rack for holding multiple trays and providing a closure for the top opening of the trays;
providing a liner for each tray, wherein the liner comprises a floor, end flaps opposite one another, side flaps opposite one another and disposed to extend orthogonally with respect to and between the end flaps;
inserting the liner in a respective tray; and
releasing the liner to contact at an upper edge of each flap thereof a corresponding container wall in the tray.

2. The method of claim 1, further comprising placing an animal in the container on the liner.

3. The method of claim 2, further comprising monitoring the condition of the liner periodically to assess the condition thereof.

4. The method of claim 3 wherein the monitoring occurs with feeding the animal.

5. The method of claim 1, further comprising providing a blank for the liner, the blank constituted by a single piece of contiguous, continuous, planar material.

6. The method of claim 5, further comprising providing fold lines in the blank by reducing the section modulus locally along the fold lines.

7. The method of claim 5, further comprising cutting a relief notch in the blank coincident with one of the fold lines.

8. The method of claim 5, further comprising providing a knockout in a region of the blank that will eventually serve as a floor of a liner.

9. The method of claim 8, further comprising die cutting the knockout to leave sufficient material connecting the knockout to the remainder of the blank in order to serve as an uninterrupted portion of the floor when the knockout is not removed.

10. The method of claim 1, further comprising folding tabs at the end of at least one of an end flap and a side flap to form a funnel wall blocking access to a corner of the tray from inside the blank, once the blank has been formed into a liner.

11. An apparatus comprising:
a habitat for a reptile comprising a rack having vertical supports and lateral supports;
trays fitted to selectively insert and remove between the lateral supports as stabilizers for the trays against vertical movement;
a ceiling positioned between the lateral supports and an open top of the tray to secure the tray against escape of an animal contained in the tray; and
a liner configured from a single piece of flat, planar material provided with relief cuts and lines of reduced section modulus defining and separating end flaps, side flaps, and tabs, wherein the liner is foldable along the lines reduced to fit into a bottom portion of the tray, with the structural properties of the liner urging an upper edge of each end flap and side flap against a corresponding wall of the tray.

12. The apparatus of claim 11 comprising tabs extending from at least one of end flaps and side flaps to contact at least one of the end flaps and side flaps to close a gap between adjacent end flaps and side flaps.

13. The apparatus of claim 11, further comprising a knockout, partially cut through a floor of the liner and partially connecting to the floor of the liner, to be removable in response to manipulation by a user, without the use of tools.

14. The apparatus of claim 13, further comprising a reservoir fixed to the tray and positioned to pass through an aperture created by removal of the knockout.

15. The apparatus of claim 11, wherein the liner is formed of a material constituted by two parallel surfaces of solid material separated by a corrugated spacer secured therebetween.

16. An apparatus comprising:
a floor constituted by two parallel layers of a solid material separated by a spacer secured therebetween;
end flaps extending continuously and contiguously from the floor and formed as extensions thereof;
side flaps formed as extensions of the floor and extending orthogonally with respect to the end flaps;
tabs extending from one of the side flaps and the end flaps to effect closure of a gap remaining between each end wall and each side wall adjacent thereto in a deployed configuration, and
the side flaps and end walls extending simultaneously outward and upward away from the floor, and to close a space by a contacting closure between an upper edge of each of the side flaps and end flaps and corresponding boundaries of a space to be lined by the apparatus.

17. The apparatus of claim 16, comprising a knockout, positioned in the floor, cut through partially and periodically to be removable from the floor, and periodically contiguous and continuous with the floor to be selectively attached to or removable from the floor.

18. The apparatus of claim 17, wherein cuts between the knockout and the floor, render the knockout removable by manipulation by hand without tools.

19. The apparatus of claim 16, further comprising a tray, the liner being sized to fit within the tray, with the side flaps and end flaps extending away from the floor of the liner at an angle greater than ninety degrees, on the inside of the liner, when installed in the tray.

20. The apparatus of claim 19, wherein the tabs operate as funnels angled inward toward the floor and downward as closures to a gap remaining between each end flap and its adjoining side flaps.
